(19) United States
(12) Patent Application Publication
(10) Pub. No.: US 2015/0350014 A1
(43) Pub. Date: Dec. 3, 2015

(54) NETWORKING IMPLEMENTATION USING A CONVERGED HIGH SPEED INPUT/OUTPUT FABRIC TECHNOLOGY

(71) Applicant: Apple Inc., Cupertino, CA (US)

(72) Inventor: Robert II McKeever, San Jose, CA (US)

(73) Assignee: Apple Inc., Cupertino, CA (US)

(21) Appl. No.: 14/337,123

(22) Filed: Jul. 21, 2014

Related U.S. Application Data
(60) Provisional application No. 62/005,789, filed on May 30, 2014.

(51) Int. Cl. H04L 12/24

(52) U.S. Cl. CPC H04L 41/0806

(57) ABSTRACT

Networking between two host devices can leverage a converged high-speed input/output fabric (“HSIO”) technology (e.g., Thunderbolt). HSIO networking can be implemented between two host devices as a “cross-domain” service. Each host device can establish a data transmit path segment to an endpoint at the boundary of its HSIO domain. A host device can send a login request to another host device and can respond to a login request from another host device by establishing a data receive path segment that connects to the endpoint location of the data transmit segment of the requesting host device. When both devices have sent and responded to login requests, a bidirectional cross-domain data transport is established and can be used to communicate network data. The HSIO networking service can present a virtual Ethernet controller interface to other software on the host device.

### CROSS REFERENCE TO RELATED APPLICATION

This application claims the benefit of U.S. Provisional Application No. 62/005,789, filed May 30, 2014, the disclosure of which is incorporated by reference herein in its entirety.

### BACKGROUND

The present disclosure relates generally to communication between computing devices and in particular to use of a converged high-speed input/output fabric technology for networking between computing devices.

Computers are a staple of daily life. In the United States, for instance, it is estimated that there is roughly one computer for every person in the country. As more and more tasks are shifted to computers, there is ever-increasing interest in enabling computers to communicate with each other. Over the years, many different standards and protocols have been developed to support communication between two or more computers, also referred to as networking.

Ethernet, which was standardized in the 1980s as IEEE 802.3, is one well-known example of a networking technology. Ethernet technology specifies protocols for communicating between computer systems, including frame length and format, use of MAC (“medium access control”) addresses to uniquely identify computer systems. Ethernet technology also specifies various physical media and parameters for propagating communication signals between computer systems, including cable types, signaling protocols, data rates, etc. Many software programs that incorporate communication with other computers assume the availability of Ethernet networking technology and may include Ethernet-specific operations. (Such software is referred to herein as being “Ethernet-aware.”)

Ethernet connectivity generally requires that the computer have an Ethernet controller, a hardware device that includes one or more connectors to which external signal cables can be removably connected. A MAC address is typically assigned to the Ethernet controller (or to each connector for a controller with multiple connectors). A driver, which can be implemented in software, is typically provided for the Ethernet controller. The driver can provide an interface between the Ethernet controller and other software executing on the computer on which the driver is installed, allowing the other software to send and receive Ethernet frames.

Some computers do not have Ethernet controllers and therefore do not support Ethernet connectivity. If a computer does not have Ethernet connectivity, Ethernet-aware software might not be usable on that computer.

### SUMMARY

Given the prevalence of Ethernet-aware software, it is desirable to allow such software to execute on computers that may not have Ethernet controllers or other supporting hardware. Certain embodiments of the present invention can facilitate this goal in part by providing an interface layer between Ethernet-aware software and communication hardware that supports an alternative communication technology. One example of an alternative communication technology is a converged high-speed input/output (I/O) fabric technology (referred to herein as “HSIO” technology) that allows several different data formats (e.g., PCIe, DisplayPort, etc.) to be communicated using a common signaling technology. An example of an HSIO technology can be Thunderbolt technology. (THUNDERBOLT™ is a trademark of Intel Corp. of Santa Clara, Calif., used to designate a specific HSIO technology promulgated by Intel Corp.; the term “Thunderbolt” is used herein in reference to this technology.)

In accordance with some embodiments of the present invention, a software interface layer can be provided between an Ethernet-aware networking software stack that can generate Ethernet frames and underlying hardware that supports HSIO technology, thereby providing a capability referred to herein as “HSIO networking.” A computer that supports HSIO networking can execute Ethernet-aware software internally, while presenting itself to other computers as a computer with HSIO technology. Two computers that support HSIO networking as described herein can communicate when connected in a manner that allows Ethernet-aware software on both computers to perform as if an Ethernet connection were present, regardless of whether either or both computers has or lacks an Ethernet controller.

In some embodiments, including embodiments that leverage Thunderbolt technology, a host device (e.g., a computer) can be considered part of a “domain” of devices connected using HSIO technology. A domain can be limited to having only one host, and a “domain boundary” can be said to exist between hosts that are connected using HSIO technology. In such embodiments, HSIO networking can be implemented between two host devices as a “cross-domain” service. For example, a first host device can define a data transmit path segment from an origin point within the first host device to a specific location at its domain boundary (such as a Thunderbolt hopID). A second host device, which can be the host for the adjacent domain, can connect a data receive path segment from the location of the data transmit path segment at the domain boundary to a termination point within the other host device. Thus, a cross-domain data transmit path from the first host device to the second host device can be established. The same procedure can be used, with the roles reversed, to establish a cross-domain data transmit path from the second host device to the first host device. (From the perspective of the first host device, the latter path would be a cross-domain data receive path.) When paths in both directions are established, the paths can be used to transfer Ethernet frames encapsulated in HSIO-compliant packets (e.g., Thunderbolt packets).

To operate consistently with Ethernet, each HSIO connector port on a computer system can be assigned a MAC address. The assignment can be arbitrary, provided that the MAC addresses assigned to different ports and different computer systems are different from each other. Some embodiments provide that the MAC address for an HSIO port can be derived from unique identifiers associated with the HSIO hardware.

In some embodiments, the process used to establish an HSIO networking connection allows either of two host devices to initiate the connection by sending a login request to the other via a cross-domain control path that can be established between the host devices, e.g., when a cable is connected between them. The login request can include an identifier (e.g., a Thunderbolt hopID) for a location at which a data transmit path segment originating from the host device terminates at the domain boundary. Other information, such as the MAC address of the sender, can also be provided. The host that receives the login request can connect a data receive path segment to the data transmit path segment at the domain boundary and can respond on the cross-domain control path with its own MAC address. Thus, a login request from a first host to a second host can result in establishing a cross-domain data transmit path from the first host to the second host, without either host needing to establish a path or path segment outside its own domain. To establish a cross-domain data transmit path in the other direction, the second host can send a login request to the first host. The two hosts can send login requests independently of each other and in any order. It is not required (although it can be the case) that either host sends a login request in response to a received login request. This bidirectional login protocol can provide a simple mechanism for establishing cross-domain data transfer paths in both directions between two host devices, with little or no negotiation.

Once established, the cross-domain data transfer paths can be used as a virtual Ethernet connection to transfer Ethernet frames that have been encapsulated into HSIO-compliant packets. Like an Ethernet connection, the cross-domain data transfer paths can be maintained in existence indefinitely or terminated when appropriate.

Bidirectional login processes as described herein can be used to establish a point-to-point HSIO networking connection between two host devices. In some embodiments, a host device that has two (or more) HSIO connection ports available can establish point-to-point HSIO networking connections with each of two (or more) other host devices. Such a host device can provide an Ethernet bridge functionality, allowing more than two host devices to be connected using HSIO networking

The following detailed description together with the accompanying drawings will provide a better understanding of the nature and advantages of the present invention.

### BRIEF DESCRIPTION OF THE DRAWINGS

FIG. 1 shows two host devices connected to provide Ethernet networking via Thunderbolt technology according to an embodiment of the present invention.

FIG. 2 shows a connection between Thunderbolt router chips of two host devices that can be used to support Ethernet networking according to an embodiment of the present invention.

FIG. 3 is a simplified illustration of a software stack according to an embodiment of the present invention.

FIG. 4 illustrates examples of software objects that can be implemented in a Thunderbolt networking layer according to an embodiment of the present invention.

FIG. 5 is a flow diagram of a process for publishing a Thunderbolt networking service by a host device according to an embodiment of the present invention.

FIG. 6 is a flow diagram of a process for discovering another host device that supports Thunderbolt networking according to an embodiment of the present invention.

FIG. 7 is a flow diagram of a process for establishing a cross-domain data transmit path according to an embodiment of the present invention.

FIG. 8 shows a flow diagram of a process for establishing a cross-domain data receive path according to an embodiment of the present invention.

FIG. 9 illustrates three host devices connected in a bridge configuration using Thunderbolt cables.

FIG. 10 is a simplified block diagram of a representative computer system that can be used to implement a host device.

### DETAILED DESCRIPTION

Certain embodiments of the present invention can provide a software interface layer between an Ethernet-aware networking software stack that can generate Ethernet frames and underlying hardware that supports a converged high-speed I/O technology (referred to herein as “HSIO technology”), thereby providing a capability referred to herein as “HSIO networking.” For purposes of clarity, the following description uses Thunderbolt technology (a specific HSIO technology promulgated by Intel Corp. under the Thunderbolt™ brand name) as an example of an HSIO technology that can be used in implementing an embodiment of the invention.

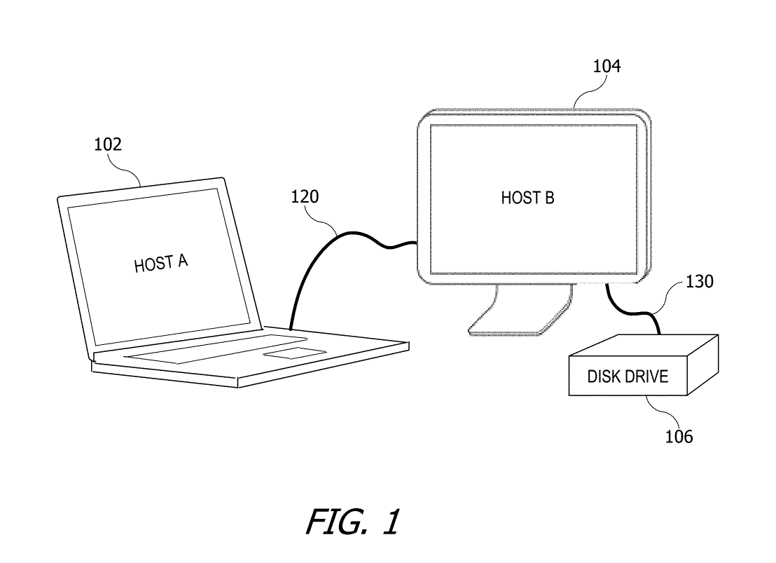

FIG. 1 shows two host devices connected to provide Ethernet networking via Thunderbolt technology according to an embodiment of the present invention. Host device A 102 in this example is a laptop computer, and host device B 104 is a desktop computer. Host devices A 102 and B 104 are connected by cable 120. Host B 104 is connected to a peripheral device 106 (in this case an external disk drive) by cable 130. Although not shown, cables 120 and 130 can each have a plug connector at either end that is sized and shaped to be received in a receptacle connector of the devices they connect. The form factor of the connectors can be varied as desired.

Information can be transmitted over cables 120 and 130 in either direction. In certain embodiments, the information can include Ethernet packets that have been encapsulated or otherwise converted into Thunderbolt packets for purposes of transmission. In this manner, Ethernet packets can be communicated between host device A 102 and host device B 104.

Various types of circuitry can be used to create and process signals transmitted and received over cables 120 and 130. For example, router devices or chips located within host devices A 102 and B 104 and within peripheral device 106 can be used to transmit and receive data over cable 120. In some embodiments, the router devices or chips can be “Light Peak” chips developed at least in part by Intel Corp. of Santa Clara, Calif.; other chips or devices can also be used. Data exchange via cables 120, 130 can conform to protocol specifications (e.g., packet size, packet format, packet rate, etc.) based at least in part on the capabilities of the router chips.

As described below, the router devices or chips can perform encapsulation of Ethernet packets into Thunderbolt packets for transmission. In the meantime, software executing in the router devices or chips or elsewhere within the host devices can perform other operations such that Ethernet-aware applications and/or operating-system processes can be presented with what appears to be an Ethernet-controller interface, while the underlying hardware (e.g., Thunderbolt hardware) is not Ethernet compliant. The term “Thunderbolt networking” is used herein to refer generally to the software and hardware services that provide the appearance of an Ethernet-controller interface to internal processes of a host device while the actual physical communication with other devices is based on Thunderbolt hardware and protocols rather than Ethernet hardware and protocols. Thunderbolt networking is a specific example of HSIO networking

In some embodiments, physical cable 120 can support multiple virtual data paths that transfer data between host device A 102 and host device B 104. These data paths can include paths to transmit and receive Ethernet packets that have been encapsulated in Thunderbolt packets. Paths can also be defined between host device B 104 and peripheral device 106. Paths can be configurably defined and redefined in device software.

As used herein, a “host” device can be any device that presents as a host device to other devices connected to cable 120. For example, a host device can be a device with a CPU that is capable of operating in a standalone mode, as is the case for host A 102 and host B 104. A host device can also be a device that initiates enumeration of a Thunderbolt (or other HSIO) interface to discover connected devices and establish paths to those devices. A peripheral device (e.g., device 106) can be a device that does not operate in a standalone mode and/or that does not initiate enumeration of a Thunderbolt (or other HSIO) interface but can respond to enumeration requests.

In some embodiments, each host device can be said to have its own “domain,” which can include zero or more attached peripheral devices that are downstream of it. For example, host device A 102 can enumerate its Thunderbolt interface by sending out an appropriate message along cable 120 and receiving a response from a connected device at the other end. A response from host device B 104 can indicate that B is another host device, and this can terminate the enumeration process for host device A 102. Host A 102 in this example is considered to be in a domain by itself.

Host device B 104 can enumerate its Thunderbolt interface by sending out appropriate messages on each of cables 120, 130 and receiving responses from connected devices. A response from host device A 102 can indicate that A is another host device, terminating the enumeration on cable 120. A response from peripheral device 106 can indicate that it is a disk drive. Although not shown in FIG. 1, in the case of peripheral 106, there can be another “downstream” (relative to host B 104) device attached, e.g., in a daisy-chain topology, and peripheral 106 can report the existence of that device to host B 104, allowing the enumeration to continue with host B next contacting the downstream device. Peripheral device 106 (and any other downstream devices that might be connected thereto) can be considered in the domain of host device B. A host device can define paths to connect to any of its downstream devices, and a path can have one or more hops, with each hop connecting adjacent downstream devices.

There is said to be a “domain boundary” between host device A and host device B. Accordingly, host device A is able to detect that host device B is present but not able to detect devices downstream of B (e.g., device 106), while host device B is similarly able to detect that host device A is present but not able to detect any devices that might be present downstream of host device A. Any path defined by host device A in the direction of host device B terminates at the domain boundary, and any path defined by host device B in the direction of host device A also terminates at the domain boundary.

It will be appreciated that the configuration of FIG. 1 is illustrative and that variations and modifications are possible. Host devices can be connected directly, as shown, or indirectly, e.g., via one or more intervening peripheral devices. Each host can have any number of downstream peripheral devices (including zero), and the number of devices that can connect directly to a host device can be increased or decreased as desired, e.g., by providing more or fewer connector ports. In some embodiments, the number of peripherals may be limited by system resources, such as the number of paths of a particular type that a host device can concurrently support.

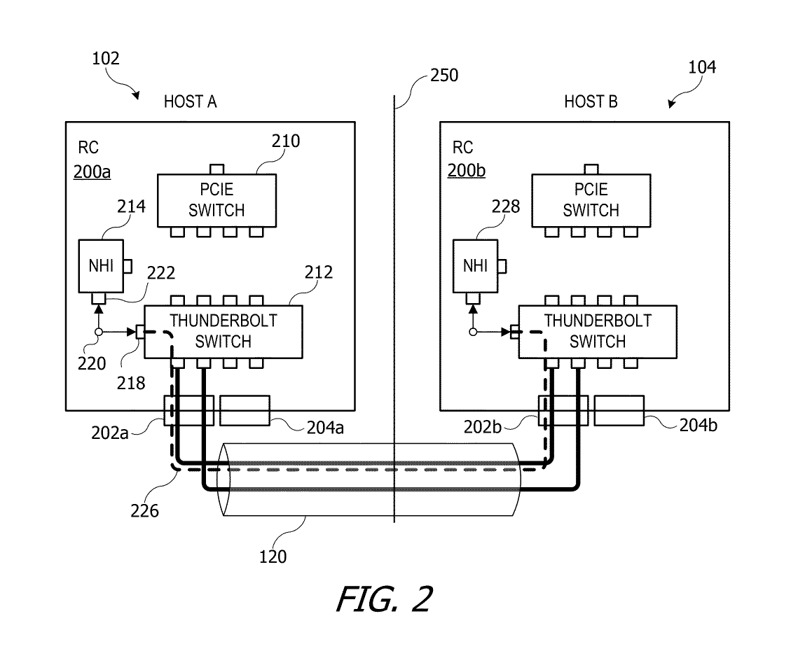

In some embodiments, Thunderbolt connectivity can be supported using router chips installed in each compatible host and peripheral device. FIG. 2 shows a connection between Thunderbolt router chips of host device A 102 and host device B 104 of FIG. 1 that can be used to support Ethernet networking according to an embodiment of the present invention. In this example, router chip 200a can be disposed within a housing of host device A 102, and router chip 200b can be disposed within a housing of host device B 104. Connector interfaces 202a, 204a, 202b, 204b can be provided to allow an external cable (e.g., cable 120) to connect to router chips 200a, 200b. Router chips 200a, 200b can have similar or identical configurations. Accordingly, while the following description focuses on router chip 200a, it is to be understood that the description can also apply to router chip 200b.

Router chip 200a can include a PCIe switch 210, a Thunderbolt switch 212, and a Native Host Interface (NHI) 214. Thunderbolt switch 212 can configurably connect any of its inputs to any of its outputs, with the configuration being controlled by software. In this example, for purposes of Thunderbolt networking support, Thunderbolt switch 212 is shown as having a bidirectional I/O port 218 connected via an adapter 220 to a corresponding port 222 of NHI 214. Adapter 220 can convert between data formats understood by NHI 214 and Thunderbolt packets. Thus, as indicated by dashed line 226, a path can be created between NHI 214 in router chip 200a and the corresponding NHI 228 in router chip 200b. It is to be understood that Thunderbolt switch 212 can also provide other connections and paths not explicitly shown, including PCIe connections and DisplayPort connections.

NHI 214 can concurrently define and manage multiple paths (e.g., 32 or more) through its single physical connection with Thunderbolt switch 212, and all paths described herein can be multiplexed through one connector port 202a of host device A 102 (and similarly at host device B 104).

As described above, a domain boundary 250 can be said to exist between host device A 102 and host device B 104. However, in some embodiments of the present invention, host device A 102 and host device B 104 can provide “cross-domain” services, a term that refers generally to services that one Thunderbolt host device can choose to make available to another. In some embodiments, when one host device discovers another (e.g., through enumeration as described above), the host devices can establish a control path between them. The control path can be a low-bandwidth path. A host that has cross-domain services available can advertise these services, e.g., by propagating a “cross-domain dictionary” on the control path. A cross-domain dictionary can be maintained, e.g., in NHI 214. The cross-domain dictionary can identify the available cross-domain services and optionally provide additional information to enable another host device to connect to or otherwise invoke one or more of the cross-domain services. In some embodiments, Thunderbolt networking can be implemented as a cross-domain service and listed in the cross-domain dictionary by any host that supports the service. If two hosts that each support Thunderbolt networking as a cross-domain service establish a control path, the hosts can choose to initiate Thunderbolt networking, e.g., using processes described below.

If Thunderbolt networking is initiated, host devices A 102 and B 104 can establish additional data paths between NHI 214 of router chip 200a and NHI 228 of router chip 200b. Each data path can be a unidirectional path; accordingly two data paths can be created to provide bidirectional data communication, as is typical between Ethernet devices. These data paths cross domain boundary 250. When a data path crosses a domain boundary, the transmitting device for the path can defines a path segment up to the domain boundary, with the path segment ending at a Thunderbolt hopID corresponding to the domain boundary. The receiving device can define another path segment from the domain boundary to the receiving end of the path, thereby completing a cross-domain data transfer path. Example processes for establishing cross-domain data transfer paths are described below.

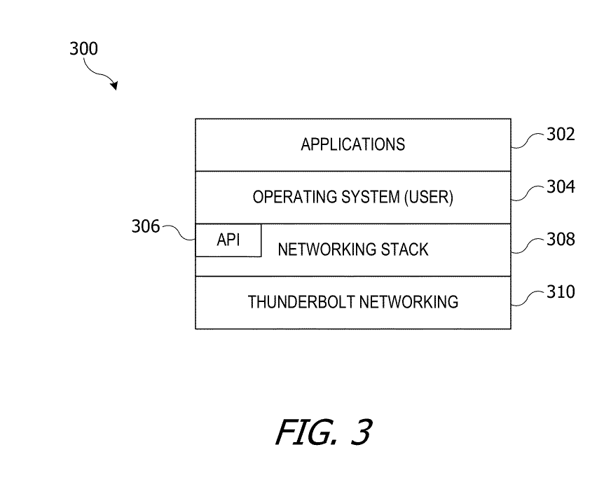

As noted above, the use of Thunderbolt networking can be transparent to other processes in the host devices. FIG. 3 is a simplified illustration of a software stack 300 according to an embodiment of the present invention. Software stack 300 can abstract the Thunderbolt networking features from other processes and protocol stacks. In some embodiments, software stack 300 can be separately implemented in each of host device A 102 and host device B 104.

Software stack 300 can include an application layer 302 and an operating system (OS) user layer 304. These layers can include conventional application and operating system programs that may rely on networking functions (e.g., exchanging data with other devices). Networking functions can be supported by a networking stack 308 that can also be of conventional design. Networking stack 308, which can be part of an operating system kernel, can provide an application program interface (API) that application layer 302 and OS user layer 304 can invoke to access networking functionality. In some embodiments, networking stack 308 can include multiple software layers (not shown).

In some conventional arrangements, networking stack 308 might invoke functions of an Ethernet controller using an Ethernet controller driver that can be part of the OS kernel, thereby delivering data to a standard Ethernet port. Further, networking stack 308 can provide an Ethernet-aware API 306 to upper layers of stack 300. Thus, any or all of layers 302, 304, 306 can include Ethernet-aware software.

In certain embodiments of the present invention, all or part of an Ethernet controller driver can be replaced by a kernel extension or other software, represented in FIG. 3 as Thunderbolt networking layer 310. Thunderbolt networking layer 310 can provide alternative implementations of functions associated with an Ethernet controller driver, with the alternative implementations being specifically adapted for Thunderbolt technology. Examples of software objects and functionalities that can be implemented in Thunderbolt networking layer 310 are described below. It is also noted that the same networking stack 308 used for conventional Ethernet networking can be used without modification in connection with Thunderbolt networking, and that networking stack 308 and all layers above (e.g., layers 304, 302) need not be aware that Thunderbolt networking layer 310 exists.

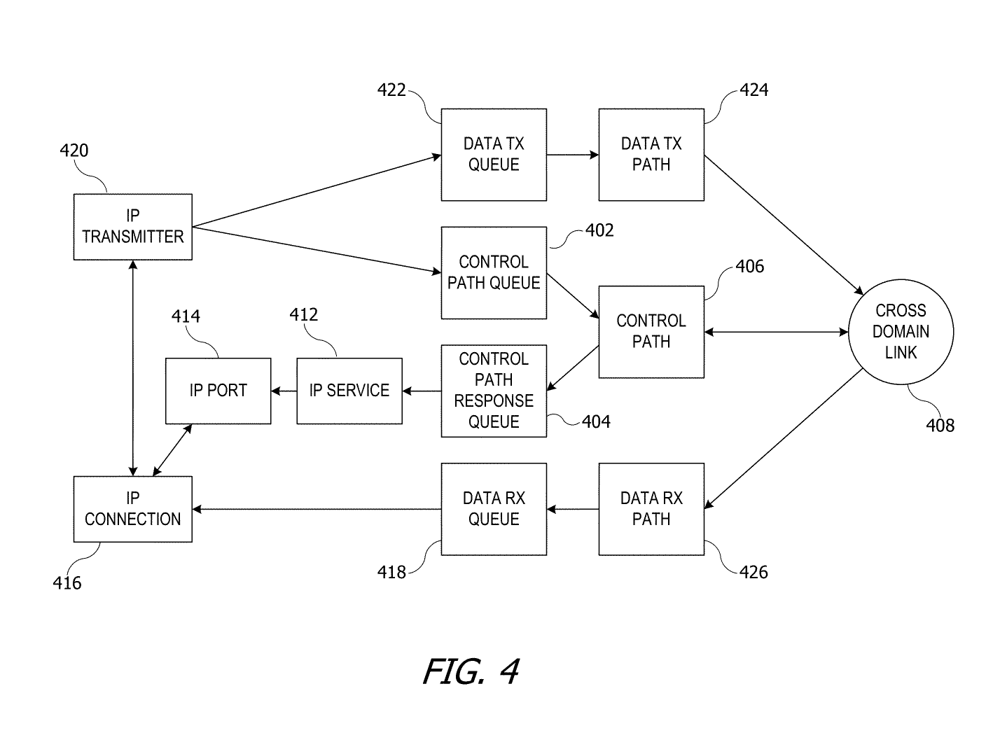

FIG. 4 illustrates examples of software objects that can be implemented, e.g., in Thunderbolt networking layer 310, according to an embodiment of the present invention. Collectively, the software objects of FIG. 4 can provide a Thunderbolt networking interface for a host device (e.g., host device A 102). While the description may make specific reference to hos device A 102 of FIGS. 1 and 2, it is to be understood that each host device in a Thunderbolt networking environment can implement a similar set of software objects. The arrows connecting the various software objects indicate the primary directions of flow for data and control messages and are not limiting as to direction(s) in which information can be communicated between software objects.

In this example, control path queue 402 and control path response queue 404 can be created separately from and independently of any use of Thunderbolt networking. For example, when host device A 102 detects that another host device is present, host device A 102 can automatically create control path queue 402 and control path response queue 404 to manage outgoing and incoming messages on control path 406, which can be connected to the other host device (e.g., host device B 104) by cross-domain link 408. As described above, control path 406 can be used to determine that host device B 104 supports Thunderbolt networking

IP service object 412 can be instantiated automatically, e.g., with one instance for each NHI. In examples described herein, it is assumed that host device A 102 has one router chip 200a with one NHI 214, so there would be one instance of IP service object 402; however, some host devices can have multiple router chips and some router chips might have multiple NHIs. IP service object 412 can coordinate the creation of other objects.

For example, IP service object 412 can create one or more instances of IP port object 414. In some embodiments, one instance of IP port object 414 is created for each Thunderbolt port on host device A 102. In the embodiment of FIG. 2, host A 102 has two ports 202a, 204a, and two instances of IP port object 414 can be created. IP port object 414 can be similar to an Ethernet controller software object (e.g., a subclass thereof) and can provide an interface between networking stack 308 of FIG. 3 and Thunderbolt hardware. In some embodiments, IP port object 414 can also be responsible for publishing Thunderbolt networking as a cross-domain service, e.g., by adding a descriptor of the service to the cross-domain dictionary maintained by NHI 214 for host device A 104. The cross-domain dictionary can be advertised by sending an outgoing message (or messages) on control path 406, and a cross-domain dictionary from another host device can be received as an incoming message (or messages) on control path 406.

IP port object 414 can have attached thereto an IP connection object 416. IP connection object 406 can manage a data receive (RX) queue 418 and can relay received packets to IP port object 414 for propagation to networking stack 308. Data receive queue 418 can be a software wrapper object around a DMA ring buffer (or other hardware) used to hold incoming data.

IP transmitter object 420 can provide the main connection to cross-domain networking services. In some embodiments, IP transmitter object 420 can read incoming dictionaries from other host devices and detect a match to a Thunderbolt networking service. In addition, IP transmitter object 420 can receive outbound network packets from network stack 308, build them into transmit commands, and push the transmit commands onto a data transmit (TX) queue 422. Like data receive queue 418, data transmit queue 422 can be a software wrapper object around a DMA ring buffer (or other hardware) used to hold outgoing data.

When data TX path 424 and data RX path are connected (via cross-domain link 408) to another host device, a bidirectional data communication path can be provided.

It will be appreciated that the software stack and software objects described herein are illustrative and that variations and modifications are possible. Embodiments of the present invention can be implemented using a number of different techniques, object models, APIs, and the like. The existence and/or implementation of Thunderbolt networking can be transparent to upper layers in a software stack, which conveniently allows Ethernet-aware software to be used without modification; however, transparency to upper layers is not required.

Processes for establishing a Thunderbolt networking connection, including data transmit path 424 and data receive path 426, will now be described. The processes described herein can be implemented, e.g., in Thunderbolt networking layer 310 of FIG. 3, and some or all of the processes (or portions thereof) can be implemented in the various software objects of FIG. 4. Further, while the processes are described as being performed by host device A 102, it is to be understood that host device B 104 (or any other host device with which host device A might share a domain boundary) can perform the same processes concurrently with host device A. Thus, the processes can be generalized, e.g., to a first host device and a second host device.

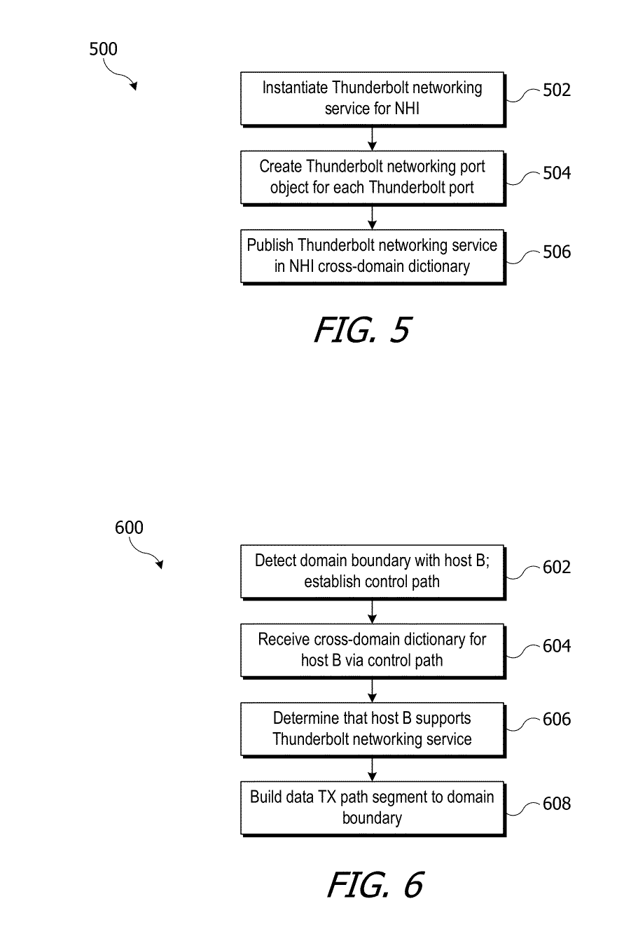

FIG. 5 is a flow diagram of a process 500 for publishing a Thunderbolt networking service by host device A 104 according to an embodiment of the present invention. Process 500 can be performed, e.g., during bootup operations of host device A, during initialization (or reset) of router chip 200a, or at other times as desired.

At block 502, host device A can instantiate a networking service for NHI 214. For instance, host device A can instantiate IP service object 412 as described above.

At block 504, host device A can create a Thunderbolt networking port object for each of its Thunderbolt ports. For instance, host device A can instantiate IP port object 414 as described above. In some embodiments, networking objects can be instantiated prior to knowing what, if any, devices might be connected to the Thunderbolt ports.

At block 506, host device A can publish its Thunderbolt networking service to its NHI cross-domain dictionary. For instance, IP port object 414 can add a descriptor for the Thunderbolt networking service into a cross-domain dictionary maintained within NHI 214. The descriptor can include a service name, an identifying number or character string associated with the Thunderbolt networking service and/or other information.

In some embodiments, process 500 can also include instantiating other software objects such as IP connection 416 and IP transmitter 420.

At this point, host device A is prepared to announce that it provides a Thunderbolt networking service and to detect the presence of another host device with a corresponding service. For instance, if host device B (or another host device) connects to control path 406, host device B can receive host device A's cross-domain dictionary including the Thunderbolt networking service descriptor.

FIG. 6 is a flow diagram of a process 600 for discovering another host device that supports Thunderbolt networking according to an embodiment of the present invention. Process 600 can be performed, e.g., during an initial enumeration of the Thunderbolt interface by host device A, or at a later time such as when a new Thunderbolt connection is detected.

At block 602, host device A can detect a domain boundary with host device B (or another host device) and establish a control path, e.g., control path 406. Conventional or other techniques for detecting another host device and establishing a control path can be used. At block 604, host device A can receive a cross-domain dictionary from host device B via the control path. At block 606, host device A can determine, based on the received cross-domain dictionary, that host device B provides a Thunderbolt networking service. At block 608, host device A can build a data transmit path segment (e.g., data transmit path 424) to the domain boundary. In some embodiments, the data transmit path segment can be a single hop (e.g., as in FIG. 2 where host device A is directly connected to host device B). In other embodiments, host device A can have one or more downstream peripherals between itself and the domain boundary, and the data transmit path segment built at block 608 can include multiple hops. In any event, host device A can determine a hop ID (or other identifier) for the endpoint of the data transmit path segment at the domain boundary.

It should be understood that host devices are not required to provide a Thunderbolt networking service (or indeed any cross-domain services). In instances where the information received at blocks 604 and 606 indicates that the connected host device does not support Thunderbolt networking, process 600 can end, and host device A can continue with other operations unrelated to the present disclosure.

Upon completion of process 600, host device A can know that it is connected to another host device (e.g., host device B) that supports Thunderbolt networking, and host device A can have established its segment of a data transmit path to which host device B can connect. However, an Ethernet connection cannot be said to be established at this stage, as data transmit and receive channels have not yet been established. In some embodiments, host device A can communicate the connection status to networking stack 308, e.g., indicating that a network is available but host device A is not connected to it.

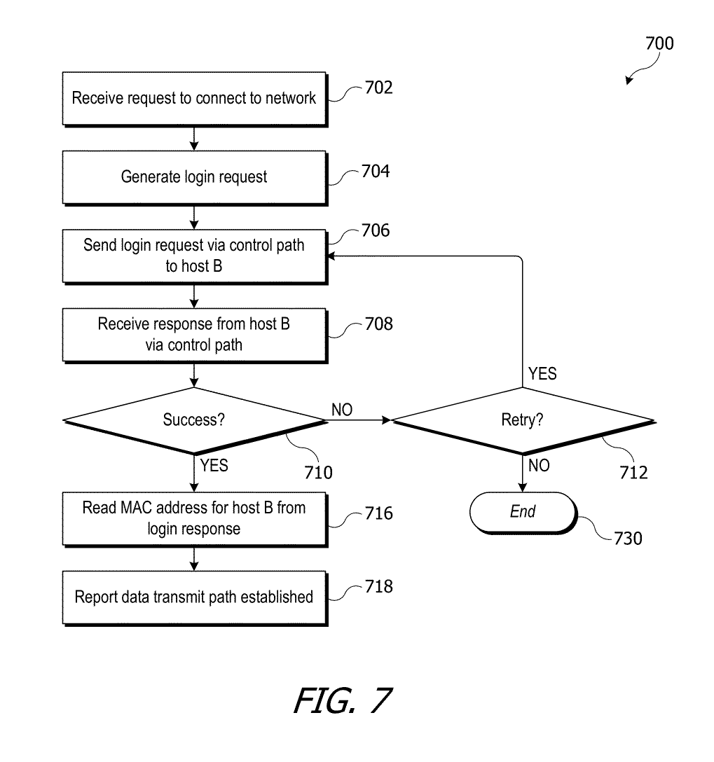

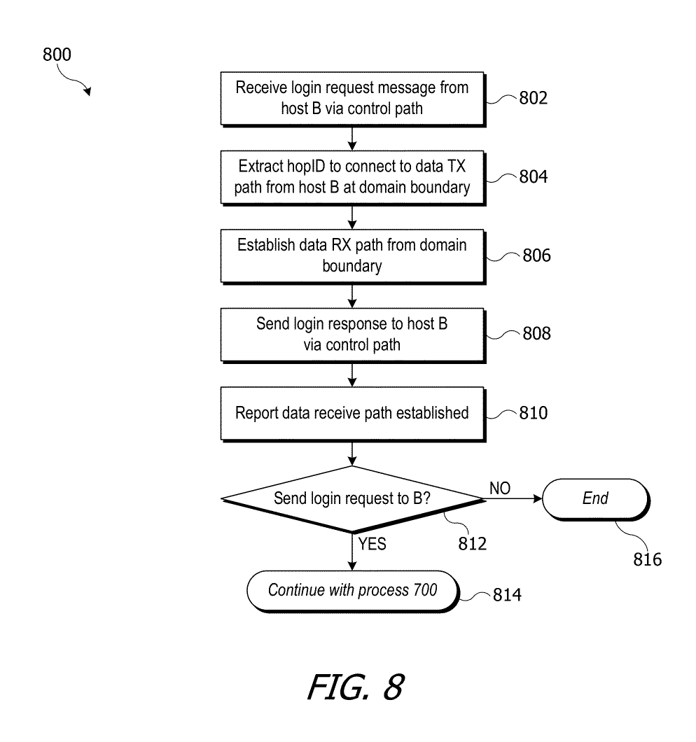

In some embodiments, establishing the Ethernet connection is based on a bidirectional login process, in which each host device logs into the other. FIGS. 7 and 8 illustrate processes for establishing data transmit and data receive paths using Thunderbolt networking according to an embodiment of the present invention.

FIG. 7 is a flow diagram of a process 700 for establishing a cross-domain data transmit path according to an embodiment of the present invention. While process 700 is described as being performed by host device A, it is to be understood that host device B can also perform the process.

Process 700 can begin at any time after successful completion of process 600. For example, at block 702, process 700 can begin when host device A receives a request to establish an Ethernet connection. In some instances, the request may be originated by networking stack 308 or another layer of stack 300. In other instances, the request can be generated within Thunderbolt networking layer 310; an example is described below.

At block 704, host device A can generate a login request. The login request can indicate a request by host device A to access the Thunderbolt networking service of host device B. The login request can also include any information needed by host device B to establish a path for receiving data from host device A. For instance, the login request can include the hop ID for the domain-boundary endpoint of data TX path (denoted “hopID(A)”), the Thunderbolt unique identifiers of host device A and/or host device B (which can facilitate addressing of Thunderbolt packets), and other information as desired. For example, the login request can be in a Thunderbolt packet that contains a Thunderbolt header (including Thunderbolt unique identifiers of the source and destination, a protocol identifier), a packet type indicator, a command ID (which can be a login-request command ID), a protocol version identifier, hopID(A), and additional option indicators as desired.

In some embodiments, the login request can also include other information, such as an Ethernet-compliant MAC address for host device A. A standard MAC address (conforming to the current Ethernet specification) is 48 bits. However, host device A might not have a MAC address that it can use. For instance, a Thunderbolt interface or router chip generally does not have an assigned MAC address, and if host device A happens to have a physical Ethernet port, using that MAC address for Thunderbolt networking could create confusion if some other Ethernet device connects to the physical Ethernet port. Accordingly, it may be desirable to generate a MAC address that host device A can use specifically for Thunderbolt networking For example, host device A can derive its MAC address from a unique Thunderbolt identifier assigned to the Thunderbolt routing chip that is executing Thunderbolt networking Depending on how Thunderbolt identifiers are assigned, this may entail compression or expansion of the Thunderbolt identifier to provide a 48-bit MAC address. As long as the same MAC address is not used by another device to which host device A connects, any address can be used. In some embodiments, the MAC address for host device A can be generated or selected prior to execution of process 700, e.g., during initial setup of the Thunderbolt networking service in process 500. It should be noted that the Thunderbolt networking layer of host device B does not need the MAC address of host device A in order to receive packets. Accordingly, the MAC address of host device A need not be provided to the Thunderbolt networking layer of host device B in the login request or any other communication. (Assuming a Thunderbolt networking connection is established, the networking stack of host device B can obtain the MAC address for host device A, e.g., as the sender's address of an Ethernet frame sent from host device A.)

At block 706, host device A can send the login request via the control path to host device B, and at block 708, host device A can receive a response from host device B via the control path. The response can be a success response (e.g., a login response providing further information pertaining to the connection) or a failure or error message. In some embodiments, host device A can wait for a response after sending the login request at block 706, and if no response is received within a timeout period (e.g., 1 second, 5 seconds, or the like), host device A can treat this as an error or failure.

If, at block 710, the response is not a success response, then at block 712, host device A can determine whether to retry. In some embodiments, host device A can retry a fixed number of times or retry any number of times within a fixed retry window of time. A decision at block 712 to retry can return process 700 to block 706 to send the login request message again. In some embodiments, depending on the particular response, host device A can modify the login request and/or wait for some amount of time (e.g., a randomly-selected interval) before retrying. If host device A decides not to retry, process 700 can end at block 730.

If, at block 710, the response is a success response (e.g., a login response), then at block 716, host device A can read additional information from the login response. In some embodiments, the information can include a MAC address for host device B (which can be generated similarly to the MAC address of host device A). The login response can also confirm that host device B has connected to the data transmit path segment ending at hopID (A), meaning that a cross-domain data transmit path from host device A to host device B has been established. In some embodiments, the login response can be a Thunderbolt packet that contains a

Thunderbolt header, a packet type indicator, a command ID (which can be a login-response command ID), a status indicator (e.g., success or failure), a MAC address of host device B, and additional option indicators as desired.

At block 718, host device A can report that the data transmit path to host device B has been established. In some embodiments, this can be reported to networking stack 310. In other embodiments, host device A can update its Thunderbolt networking state to record that its data transmit path segment is now connected to host device B but defer reporting to networking stack 310 until both a data transmit path and a data receive path have been established.

FIG. 8 shows a flow diagram of a process 800 for establishing a cross-domain data receive path according to an embodiment of the present invention. Although process 800 is described as being performed by host device A, it should be noted that in some sense process 800 is complementary to process 700 and that host device B can perform process 800 in response to the login request sent from host device A at block 706 of process 700.

At block 802, host device A can receive a login request message from host device B via the control path. The login request message can include similar information to the login request message described above with reference to block 704 of process 700, e.g., a hop ID for the domain-boundary endpoint of a data transmit path segment originating from host device B (denoted “hopID(B)”) and/or other information as described above. At block 804, host device A can extract hopID(B), and at block 806, host device A can establish a data receive path segment (e.g., data receive path 426 of FIG. 4) from hopID(B) to host device A (e.g., to data receive queue 418 of FIG. 4).

At block 808, host device A can send a login response to host device B via the control channel. The login response can be a success response, assuming no errors occurred. The success response can include similar information to the login response described above with reference to block 716 of process 700, e.g., the MAC address for host device A (which can be generated as described above with reference to FIG. 7). Consistently with Ethernet standards, a port of a host device should use the same MAC address for all login requests and login responses. If an error occurred at any preceding block of process 800, the login response can be an error response.

At block 810, assuming no errors occurred, host device A can report that the cross-domain data receive path from host device B has been established. In some embodiments, this can be reported to networking stack 310 (including the MAC address of host device B). In other embodiments, host device A can update its Thunderbolt networking state to record that its data receive path segment is now connected to host device B but defer reporting to networking stack 310 until both a cross-domain data transmit path and a cross-domain data receive path have been established.

In some embodiments, if a cross-domain data receive path has been established but a cross-domain data transmit path has not, this condition can prompt host device A to attempt to establish the cross-domain data transmit path. For example, at block 812, if a cross-domain data transmit path to host-device B has not been established, host device A can decide to send a login request to host device B in order to establish the cross-domain data transmit path. If this decision is taken, then at block 814, host device A can continue with process 700, which can be used to establish the cross-domain data transmit path as described above. If host device A decides not to send a login request (e.g., because the data transmit path has already been established), then process 800 can end at block 816.

It will be appreciated that the foregoing processes are illustrative and that variations and modifications are possible. Steps described as sequential may be executed in parallel, order of steps may be varied, and steps may be modified, combined, added or omitted. In some embodiments, processes 700 and 800 can be performed independently of each other and in either order. An Ethernet connection between host devices A and B can be considered as established when both the data transmit path and the data receive path (which can be Thunderbolt paths rather than an actual physical-level Ethernet connection) have been established. This bidirectional login technique can provide a simple mechanism for establishing cross-domain data transfer paths. The host devices do not need to negotiate over initiating the connection, and neither host needs the ability to define a path or path segment beyond its own domain. Each host device can construct a data transmit path segment within the host device's domain and request that the other host device complete the path. Similarly, each host device can respond to a request to complete a path by constructing a data receive segment within (but not beyond) its own domain.

Once the (virtual) Ethernet connection is established, host devices A and B can exchange Ethernet frames. For example, the networking stacks 308 in both host devices can know the MAC addresses of host device A and host device B. A host device can provide its own MAC address to networking stack 308, e.g., during stack initialization, and can provide the MAC address of another host device after it receives that information, e.g., during process 700 or 800. Networking stack 308 in a sending device (e.g., host device A) can use the MAC addresses to generate Ethernet frames in a format (including addressing) that complies with Ethernet standards. Host device A can send an Ethernet frame to host device B by receiving the Ethernet frame from networking stack 308, encapsulating the Ethernet frame in a Thunderbolt packet (which can be done, e.g., at NHI adapter 220 of FIG. 2), and propagating the Thunderbolt packet through the data transmit path to host device B. Host device B can receive the Thunderbolt packet, extract the encapsulated Ethernet frame (e.g., at NHI adapter 228 of FIG. 2), and deliver the extracted Ethernet frame to its own networking stack. Bidirectional data exchange can be supported in the same manner, and each host device can act as both sender and recipient.

In some embodiments, the Ethernet frame size can exceed the Thunderbolt packet size. For example, some implementations of Ethernet can support “jumbo” frames of up to 64 KB, while Thunderbolt frames may be limited to a smaller size, e.g., 4 KB. Where this is the case, the sender can divide an Ethernet frame into blocks of a size small enough to fit in a Thunderbolt packet and send the blocks sequentially. To the extent that Thunderbolt technology guarantees that packets can be delivered in the order in which they are sent, reassembling the Ethernet frame at the receiver end can be straightforward. Further, because Thunderbolt technology provides its own error-detection mechanism, any Ethernet error-detection information (e.g., CRC bits) generated in the networking stack at the sender side can be ignored or passed up as-received to the networking stack at the receiving end. In any event, the underlying Thunderbolt technology can be transparent to networking stack 308, which sees only the Ethernet frames.

An Ethernet connection via Thunderbolt networking as described herein can be maintained indefinitely, until a termination event occurs. Termination events can be generated, e.g., from networking stack 308 in either device, and networking stack 308 can communicate a termination instruction to Thunderbolt networking layer 310. In some instances, Thunderbolt networking layer 310 can originate a termination event, for example, if an unrecoverable error occurs or if no activity occurs over a connection for a sufficiently long time. Regardless of origin, when Thunderbolt networking layer 310 in host device A detects a termination event, it can send a logout message via the control path to host device B. In response to the logout message, host device B can release resources it had allocated to the connection with host device A. For instance, host device B can disconnect its data receive path segment. In addition, if host device B is logged in to host device A, host device B can send its own logout message, confirming that host device A can free its resources. As with login messages, either host device can send logout messages independently of the other, and logout messages can be sent in any order.

After termination of a connection, the Thunderbolt networking service on each host device can remain available (e.g., advertised via the NHI dictionary), and the host devices can reconnect or connect to other devices as desired.

Embodiments described above provide a point-to-point Thunderbolt networking connection between two devices. Ethernet network topologies are not limited to two devices. Accordingly, some embodiments of the invention can support more complex multi-host connections.

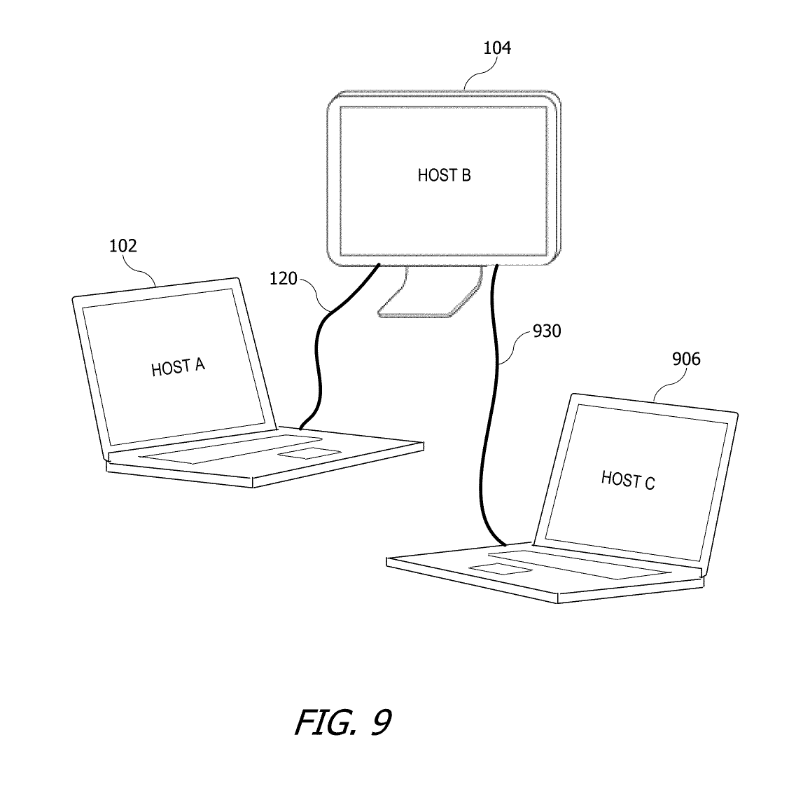

FIG. 9 illustrates three host devices connected in a bridge configuration using Thunderbolt cables that can support Ethernet networking using Thunderbolt technology according to an embodiment of the present invention. Host device A 102 and host device B 104 can be connected by cable 120 as described above with reference to FIG. 1. Host device C 906 can be connected to host device B 104 by cable 930. Cables 120 and 930 can connect to two different connector ports on host device B (e.g., ports 202b, 204b) of FIG. 2. In some embodiments, both connector ports can connect to the same router chip (e.g., router chip 200b of FIG. 2). In other embodiments, host device B 104 can have multiple router chips, and cables 120 and 930 can connect to different router chips.

In the arrangement of FIG. 9, there is a domain boundary between host device A 102 and host device B 104, and another domain boundary between host device B 104 and host device C 906. Consequently, at the level of Thunderbolt technology, host device A and host device C can be invisible to each other, while both host device A and host device C are visible to host device B.

In this example, host device B 104 can instantiate two instances of IP port object 414 of FIG. 4, one for each cable connection, and host device B 104 can present an Ethernet controller interface to networking stack 308 that includes two ports, each with its own MAC address. One instance of IP port object 414 (“port 1”) can establish a (virtual) Ethernet connection with host device A (e.g., using processes 500-800 described above or similar processes) while the other instance of IP port object 414 (“port 2”) can establish a (virtual) Ethernet connection with host device C (again using processes 500-800 described above or similar processes).

Host device B can report each of its Ethernet connections to its local networking stack 308. Networking stack 308 therefore can receive MAC addresses for host A, host B/port 1, host B/port 2, and host C. Networking stack 308 can implement an Ethernet bridge to route traffic between host device A and host device C and can inform the networking stack in each of host devices A and C of the other's presence and MAC address. Once the networking stacks in host device A and host device C have each other's MAC addresses, they can begin to address Ethernet packets to each other.

At the Thunderbolt networking layer, packets from host device A or host device C can be routed to host device B. For instance, host device B can receive the packets and pass them to its local networking stack 308. Networking stack 308 can be capable of recognizing that Ethernet packets addressed to host device C should be sent out on port 2 of host device B while packets addressed to host device A should be sent out on port 1. Networking stack 308 can provide appropriate transmission commands to Thunderbolt networking layer 310 to effect this routing.

Alternatively, Thunderbolt networking layer 310 in device B can maintain a mapping of MAC addresses to ports. Where this is the case, Thunderbolt networking layer 310 can read the Ethernet address headers and determine the routing without the involvement of networking stack 308.

The configuration shown in FIG. 9 can be further extended to additional host devices, subject to resource constraints such as the number of ports available on a device, the number of Thunderbolt paths that can be created, and so on. Further, ring topologies can also be created. For instance, in FIG. 9, if host device A and host device C each have a second Thunderbolt connector port, a cable (not shown) can be connected between them to form a ring. Provided that networking stack 308 is configured to manage an Ethernet ring topology, communication can occur, with networking stacks 308 (or optionally Thunderbolt networking layers 310) maintaining a mapping of ports to MAC addresses reachable through each port.

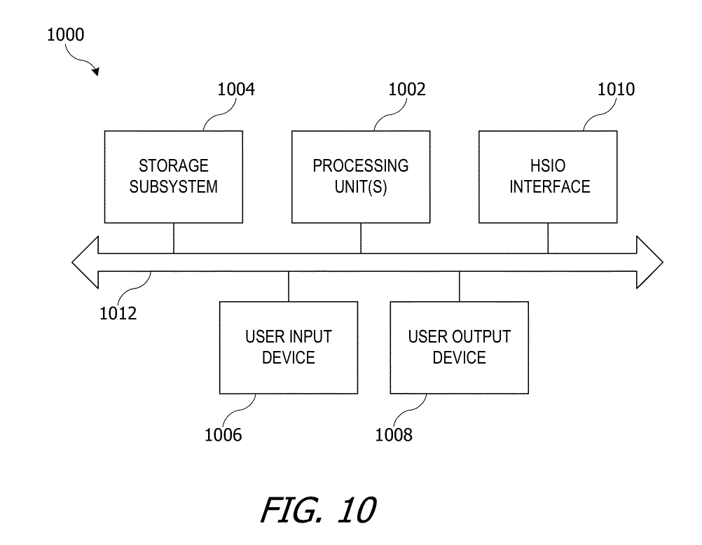

Various operations described herein can be implemented on computer systems, which can include systems of generally conventional design. FIG. 10 is a simplified block diagram of a representative computer system 1000 that can be used to implement a host device as described above (e.g., host device A 102, host device B 104, host device C 906). Computer system 1000 can include processing unit(s) 1002, storage subsystem 1004, user input devices 1006, user output devices 1008, Thunderbolt interface 1010, and bus 1012.

Processing unit(s) 1002 can include a single processor, which can have one or more cores, or multiple processors. In some embodiments, processing unit(s) 1002 can include a general-purpose primary processor as well as one or more special-purpose co-processors such as graphics processors, digital signal processors, or the like. In some embodiments, some or all processing units 1002 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 1002 can execute instructions stored in storage subsystem 1004.

Storage subsystem 1004 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 1004 can include removable storage media that can be readable and/or writeable; examples of such media include compact disc (CD), read-only digital versatile disc (e.g., DVD-ROM, dual-layer DVD-ROM), read-only and recordable Blu-Ray® disks, ultra density optical disks, flash memory cards (e.g., SD cards, mini-SD cards, micro-SD cards, etc.), magnetic disks, and so on. The computer readable storage media can include both volatile storage media (e.g., DRAM or the like) that retain their contents only while powered and non-volatile storage media (e.g., flash memory, disk) that can retain their contents even when powered down. Computer readable storage media do not include carrier waves and transitory electronic signals passing wirelessly or over wired connections. Storage subsystem 1004 can be used to store any data that is used or generated by computing system 1000.

In some embodiments, storage subsystem 1004 can store one or more software programs to be executed by processing unit(s) 1002, such as application programs and/or operating system programs, including any or all of the networking stack, Thunderbolt interface, or other software layers described above. “Software” refers generally to sequences of instructions that, when executed by processing unit(s) 1002, cause computer system 1000 to perform various operations, thus defining one or more specific machine implementations that execute and perform the operations of the software programs. The instructions can be stored as firmware residing in read-only memory and/or applications stored in non-volatile storage media that can be read into volatile working memory for execution by processing unit(s) 1002. Software can be implemented as a single program or a collection of separate programs or program modules that interact as desired. From storage subsystem 1004, processing unit(s) 1002 can retrieve program instructions to execute and data to process in order to execute various operations described herein.

A user interface can be provided by one or more user input devices 1006 and one or more user output devices 1008. User input devices 1006 can include any device via which a user can provide signals to computer system 1000; computer system 1000 can interpret the signals as indicative of particular user requests or information. In various embodiments, user input devices 1006 can include any or all of a keyboard, track pad, touch screen, mouse or other pointing device, scroll wheel, click wheel, dial, button, switch, keypad, microphone, and so on.

User output devices 1008 can include any device via which computer system 1000 can provide information to a user. For example, user output devices 1008 can include a display to display images generated by computer system 1000. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 1008 can be provided in addition to or instead of a display. Examples include indicator lights, speakers, tactile “display” devices, printers, and so on.

HSIO interface 1010 can provide HSIO connectivity (e.g., Thunderbolt technology) for computer system 1000. In some embodiments, HSIO interface 1010 can include a Thunderbolt router chip (e.g., router chip 200a described above) and one or more connector interfaces to connect to one or more other devices via a Thunderbolt cable. HSIO interface 1010 can support Ethernet networking via HSIO technology, e.g., as described above with Thunderbolt technology as an example.

In some embodiments, computer system 1000 can also include hardware and/or software components to provide other network interfaces, such as wireless communication interfaces conforming to Bluetooth, IEEE 802.11 or other wireless communication standards.

Bus 1012 can include various system, peripheral, and chipset buses that communicatively couple the numerous components of computer system 1000. For example, bus 1012 can communicatively couple processing unit(s) 1002 with storage subsystem 1004. Bus 1012 can also connect to input devices 1006 and output devices 1008. Bus 1012 can also couple computing system 1012 to one or more other devices through HSIO interface 1010.

Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

It will be appreciated that computer system 1000 is illustrative and that variations and modifications are possible. Computer system 1000 can have other capabilities not specifically described here (e.g., power management, one or more cameras, USB or other connection ports for connecting external devices or accessories, etc.). Further, while computer system 1000 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

While the invention has been described with respect to specific embodiments, one skilled in the art will recognize that numerous modifications are possible. As noted above, although the description makes specific reference to Thunderbolt technology, it is to be understood that the techniques described can be adapted to other HSIO technologies.

MAC addresses can be assigned to HSIO ports in any manner desired. In some instances, it may be desirable to avoid MAC addresses with byte0, bit 0 set true, as this is indicative of Ethernet multicast addresses. In one embodiment that can be used in the context of Thunderbolt technology, each Thunderbolt router chip has a unique identifier, and the MAC address can be derived from the identifier. For example, a 64-bit Thunderbolt identifier namespace can be hierarchically structured to include an authority ID field and an additional authority-specific field. The authority ID field can store an authority ID that is assigned (e.g., per computer manufacturer) by a central source of Thunderbolt technology (e.g., Intel Corp.) and that is the same for all Thunderbolt components used in the manufacturer's devices. The authority-specific filed can be used in any manner desired by the manufacturer. For example a manufacturer can allocate bits in the authority-specific field to a project ID, a device ID (e.g., a specific CPU), and a router ID (e.g., to distinguish Thunderbolt router chips in a device that can have multiple such chips). The authority ID field and project ID subfield (which are most likely to be the same across a large number of router chips) can be bit-order reversed and XOR'd with a portion of the device ID subfield. The result can be reconstituted into a MAC address, avoiding bits 0 and 1 of byte0 (which, as is known in the art, have special meaning in Ethernet MAC addresses). A bit in the MAC address can be set to indicate that the address is locally defined and not considered globally unique, although it is expected to be unique to the link. This technique can produce a MAC address that has a high probability of being unique among devices that would be likely to connect to each other using Thunderbolt networking

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method of providing a network connection between a first host device and a second host device that are connected using hardware compliant with a converged high-speed input/output fabric (“HSIO”) technology, the method comprising, by the first host device:
establishing a cross-domain data transmit path from the first host device to the second host device, wherein establishing the cross-domain data transmit path includes:
establishing a first data transmit path segment from the first host device to a first location at a domain boundary with the second host device;
sending a first login request to the second host device via a control path that crosses the domain boundary, the first login request including an identifier of the first location;
receiving a first login response from the second host device via the control path, the first login response indicating that the cross-domain data transmit path is established; and
establishing a cross-domain data receive path from the second host device to the first host device, wherein establishing the cross-domain data receive path includes:
receiving a second login request from the second host device via the control path, the second login request including a identifier of a second location at the domain boundary;
connecting a data receive path segment from the second location to the first host device to complete the cross-domain data receive path; and
sending a second login response to the second host device via the control path, the second login response indicating that the cross-domain data receive path is established,
wherein the network connection is established when both the cross-domain data transmit path and the cross-domain data receive path are completed.

2. The method of claim 1 wherein establishing the cross-domain data transmit path and establishing the cross-domain data receive path are performed independently of each other.

3. The method of claim 1 wherein establishing the cross-domain data transmit path is performed in response to a network connection request received from a networking stack process executing on the first host device.

4. The method of claim 3 wherein the networking stack process implements an Ethernet controller interface and the HSIO technology is transparent to the networking stack process.

5. The method of claim 1 wherein establishing the cross-domain data transmit path is initiated in response to receiving the second login message.

6. The method of claim 1 wherein the first login response includes a MAC address for the second host device.

7. The method of claim 1 wherein the second login response includes a MAC address for the first host device.

8. The method of claim 7 further comprising:
deriving the MAC address for the first host device from an HSIO device identifier assigned to the first host device.

9. The method of claim 1 wherein the HSIO technology includes Thunderbolt technology.

10. A host device comprising:
a communication interface implementing a converged high-speed input/output fabric (“HSIO”) technology, the communication interface including a connector port; and
a processing system coupled to the communication interface, the processor being configured to:
detect that the connector port is connected to a remote host device that supports an HSIO networking service;
establish a first data transmit path segment from the connector port to a domain boundary of an HSIO domain;
send a first login request via the connector port to the remote host device to request that the remote host device connect to the first data transmit path segment;
receive a second login request via the connector port from the remote host device, the second login request including a request to connect to a second data transmit path segment at the domain boundary;
connect, responsive to the second login request, a data receive path segment to the second data transmit path segment; and
determine that a networking connection is established when the first data transmit path segment and the data receive path are both connected to the remote host device.

11. The host device of claim 10, wherein the processor is further configured to:
execute a networking process to interface with an Ethernet controller; and
responsive to determining that the networking connection is established, communicate to the networking process that the networking connection is established.

12. The host device of claim 10, wherein the HSIO networking service is transparent to the networking process.

13. The host device of claim 10 wherein the processor is further configured to send the first login request independently of receiving the second login request.

14. The host device of claim 10 wherein the processor is further configured such that detecting that the connector port is connected to a remote host device that supports an HSIO networking service includes:
receiving, via a control path from the remote host, a cross-domain dictionary indicating that the remote host supports the HSIO networking service.

15. The host device of claim 10 wherein:
the communication interface is configured to store and transmit a cross-domain dictionary; and
the processor is further configured to add to the cross-domain dictionary an indicator that the host device supports the HSIO networking service.

16. The host device of claim 10 wherein the HSIO technology includes Thunderbolt technology.

17. A computer-readable storage medium having stored therein program code instructions that, when executed by a processor in a first host device, cause the first host device to perform a method comprising:
detecting that a connector port of the first host device is connected to a second host device that supports an HSIO networking service using a converged high-speed input/output fabric (“HSIO”) technology;
establishing a first data transmit path segment from the connector port to a domain boundary of an HSIO domain;
sending a first login request via a control path from the connector port to the second host device to request that the remote host device connect to the first data transmit path segment;
receiving a second login request from the second host device via the control path to the connector port, the second login request including a request to the first host device to connect to a second data transmit path segment from the second host device at the domain boundary;
connecting, responsive to the second login request, a data receive path segment to the second data transmit path segment; and
determining that a networking connection is established when the first data transmit path segment and the data receive path are both connected to the second host device.

18. The computer-readable storage medium of claim 17 wherein sending the first login request is performed independently of receiving the second login request.

19. The computer-readable storage medium of claim 17 wherein the first login request is sent in response to a network connection request received from a networking stack process executing on the processor.

20. The computer-readable storage medium of claim 19 wherein the networking stack process implements an Ethernet controller interface and the HSIO networking service is transparent to the networking stack process.

21. The computer-readable storage medium of claim 17 wherein the first login response includes a MAC address for the second host device.
